(19) United States
(12) Patent Application Publication
(10) Pub. No.: US 2013/0089082 A1
(43) Pub. Date: Apr. 11, 2013

(54) Method for Configuring an Access Scheme

(71) Applicant: Michael Bahr, Munchen (DE)

(72) Inventor: Michael Bahr, Munchen (DE)

(21) Appl. No.: 13/435,880

(22) Filed: Mar. 30, 2012

(30) Foreign Application Priority Data
Mar. 31, 2011 (EP) 11160639.8

(51) Int. Cl. H04W 48/16

(52) U.S. Cl. CPC H04W 48/16
USPC 370/338

(57) ABSTRACT

A method is provided for configuring temporal parameters of an access scheme synchronized with other access schemes in a wireless mesh network based IEEE 802.11s specifications. In conventional access schemes an unsuitable choice of parameters at different neighboring mesh stations, especially an unsuitable choice of different DTIM intervals at the different neighboring mesh stations, will lead to overlapping reservations in some intervals. Thus, a method for setting a DTIM interval of a mesh station is provided, whereby a joining mesh station determines a DTIM interval of at least one mesh station of the wireless mesh network, and whereby the joining mesh station sets its own DTIM interval to the same DTIM interval, to a multiple of the DTIM interval, or to a fraction of the DTIM interval of at least one mesh station of the wireless mesh network, wherein the factor and the divisor are positive integers.

### CROSS-REFERENCE TO RELATED APPLICATIONS

This application claims priority to EP Patent Application No. 11160639.8 filed Mar. 31, 2011. The contents of which is incorporated herein by reference in its entirety.

### TECHNICAL FIELD

This disclosure relates to a method for configuring an access scheme. Specifically, the disclosure relates to a method of configuring temporal parameters of an access scheme, the access scheme being synchronized with other access schemes in a wireless mesh network based on the specifications of IEEE 802.11s.

### BACKGROUND

In section 9.9a.3 of the known IEEE 802.11s Draft Standard for WLAN Mesh Networking, version D10.0, a deterministic access mechanism for wireless mesh networks called MCCA (Mesh Coordinated Channel Access) is described.

Hereinafter, said draft version D10.0 of the standard IEEE 802.11s is referred to as >>draft standard<<.

The time between subsequent DTIM Beacons (Delivery Traffic Indication Message) is divided into a fixed number of MCCA time slots. These time slots can be reserved between neighboring mesh stations. An MCCA reservation contains a periodic definition of so-called MCCAOPs (MCCA opportunities). An MCCAOP is a continuous set of MCCA time slots that can be used for transmission. The time between subsequent DTIM Beacons is also referred to as DTIM (delivery traffic indication message) interval, which is defined as an interval between consecutive beacons containing a DTIM.

The access scheme MCCA divides the DTIM interval into time slots of 32 μs and allows the reservation of blocks of these time slots in a distributed manner. Such a reservation consists of a set of MCCA opportunities, also referred to as MCCAOPs.

Referring to FIG. 3 which shows reserved MCCA opportunities MCCAOP within a DTIM interval INV, an example access scheme MCCA is described. The MCCA is determined by a plurality of timing parameters: An offset OFF specifies a beginning of a first MCCAOP after the beginning of the DTIM interval INV, which is assumed to begin at the very left end of a timeline T shown in FIG. 3. A periodicity specifies the number of sub-intervals SUB—each containing an MCCAOP at its beginning—scheduled in each DTIM interval INV. According to the example MCCA shown in FIG. 3, the periodicity is three. A duration DUR, finally, specifies a temporal length, or, duration DUR, of a single MCCAOP.

Implementations of this scheme resulted in a considerable drawback in that an unsuitable choice of the parameters at the different neighboring mesh stations, especially an unsuitable choice of different DTIM intervals at the different neighboring mesh stations, will lead to overlapping MCCAOPs as shown in FIG. 4. It can be easily seen in the example according to FIG. 4 that the reservations are shifting with respect to each other, so that it comes to disadvantageous overlapping of MCCAOPs in some DTIM intervals although the first DTIM interval was without overlap.

This recognized drawback led to an amendment in version D3.04 of the draft standard by imposing a requirement on all mesh stations of a wireless mesh network to deploy a DTIM interval of common length. However, version D3.04 of the draft standard did not define how to achieve this aim. Although this requirement may be suitable to achieve a synchronization within the mesh network, the problem of enforcing this requirement on the choice of the DTIM interval in a distributed wireless mesh network remains unsolved. As to the choice of an individual DTIM interval for each mesh station it is usually assumed that the requirement is fulfilled by some default value, by an external authority responsible for the configuration, or by a distributed configuration procedure which is still to be developed.

In order to implement a DTIM interval of common length, version D10.0 of the draft standard introduced a requirement on a mesh station to maintain a synchronization with its neighboring mesh stations using a DTIM interval with a duration of 2ⁿ multiplied by a constant of 100 TU or time units.

Although said requirement allows a configuration of nested DTIM intervals—larger DTIM intervals being multiples of the smallest one—the mandatory rule of this requirement removes most of the flexibility for setting the DTIM interval and restricts the possible DTIM interval values to a very limited number, which is not adequate for the possible usages of wireless mesh networks with MCCA.

### SUMMARY

In one embodiment, a method for setting a DTIM interval of a mesh station joining a wireless mesh network based on the specifications of IEEE 802.11s includes determining, by the joining mesh station, a DTIM interval of at least one mesh station being a member of the wireless mesh network, setting, by the joining mesh station, a DTIM interval of the joining mesh station, the DTIM interval being the same DTIM interval of at least one mesh station being a member of the wireless mesh network; or a multiple of the DTIM interval of at least one mesh station being a member of the wireless mesh network whereby the factor being a positive integer; or a fraction of the DTIM interval of at least one mesh station being a member of the wireless mesh network whereby the divisor being a positive integer.

In a further embodiment, said factor or said divisor is a power of a positive integer with a coefficient being a non-negative integer. In a further embodiment, said positive integer is a value of two. In a further embodiment, said positive integer is identical for all mesh stations of said wireless mesh network including said joining mesh station.

In another embodiment, a node in a mesh network includes means for performing any of the methods discussed above. In yet another embodiment, a computer program product, which contains a program code stored on a computer-readable medium and which, is executable by a processor of a node in a mesh network to perform any of the methods discussed above. In yet another embodiment, a data storage carrier stores a computer program to cause a node in a mesh network to perform any of the methods discussed above.

### BRIEF DESCRIPTION OF THE DRAWINGS

Example embodiments will be explained in more detail below with reference to figures, in which:

FIG. 1 shows an example structure of a wireless mesh network including a plurality of mesh stations, according to an example embodiment.

FIG. 2 shows an example timing diagram of sequential intervals, the intervals including a plurality of reserved time slots which are temporally arranged within an interval. The intervals are temporally arranged according to an example embodiment.

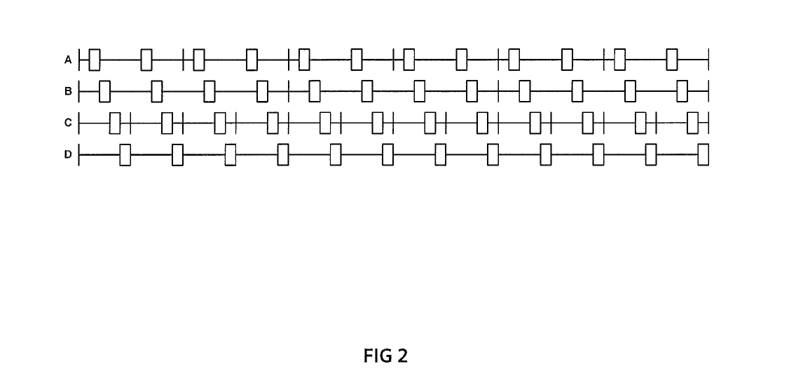

FIG. 3 shows an example timing diagram of an interval, the interval including a plurality of reserved time slots which are temporally arranged within an interval.

FIG. 4 shows an example timing diagram of sequential intervals, the intervals including a plurality of reserved time slots which are temporally arranged within an interval in accordance with a conventional technique.

### DETAILED DESCRIPTION

Some embodiments provide a method for the flexible configuration of temporal parameters of an access scheme, whereby the temporal parameters of the access scheme are set in a way that there is no relative temporal shift between MCCAOPs in different DTIM intervals over a sequence of DTIM intervals.

Some embodiments provide a distributed configuration of the access scheme, enabling each single station accessing and/or building up a mesh network to set temporal parameters of the access scheme without consulting a configuration authority and without a usage of mandatory default values.

According to an example embodiment, a method for setting a DTIM interval of a mesh is provided, whereby a joining mesh station is determining a DTIM interval of at least one mesh station being a member of the wireless mesh network, and whereby the joining mesh station is setting its own DTIM interval to the same DTIM interval; or; to a multiple of the DTIM interval; or; to a fraction of the DTIM interval of at least one mesh station being a member of the wireless mesh network whereby the factor and the divisor being a positive integer.

The time between subsequent DTIM Beacons (Delivery Traffic Indication Message) is divided into a fixed number of MCCA time slots. These time slots can be reserved between neighboring mesh stations. An MCCA reservation contains periodic definition of so-called MCCAOPs (MCCA opportunities). An MCCAOP is a continuous set of MCCA time slots that can be used for transmission. The time between subsequent DTIM Beacons is also referred to as DTIM (delivery traffic indication message) interval, which is defined is an interval between consecutive beacons containing a DTIM.

The access scheme MCCA divides the DTIM interval into time slots of 32 μs and allows the reservation of blocks of these time slots in a distributed manner. Such a reservation consists of a set of MCCA opportunities, also referred to as MCCAOP.

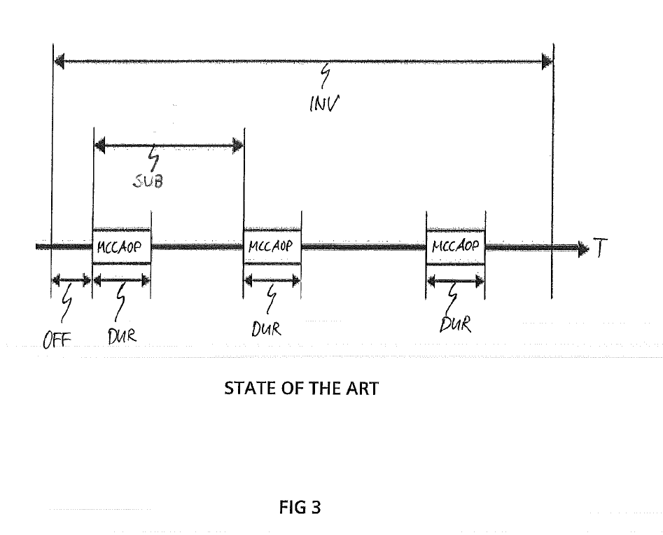

An example of an MCCAOP reservation schedule is shown in FIG. 3 within a DTIM interval INV. The MCCA is determined by a plurality of timing parameters.

A periodicity specifies the number of sub-intervals SUB—each containing an MCCAOP at its beginning—scheduled in each DTIM interval INV. In this particular example, the MCCAOP Periodicity equals three, so that there are three MCCAOPs in each DTIM interval. A duration DUR, finally, specifies a temporal length, or, duration DUR, of a single MCCAOP. As further illustrated in the FIG. 3, the MCCAOP Offset value OFF indicates the beginning of the first MCCAOP in each DTIM interval INV, which is assumed to begin at the very left end of a time-line T shown in FIG. 3.

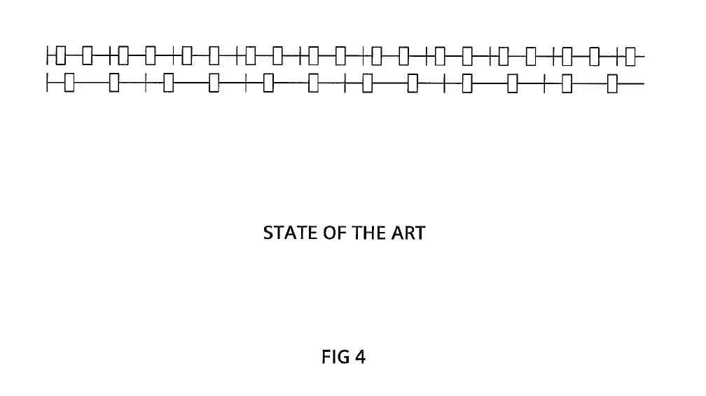

Implementations of the MCCA scheme resulted in a considerable drawback in that an unlucky choice of the parameters at the different neighboring mesh stations, especially an unlucky choice of different DTIM intervals at the different neighboring mesh stations, will lead to overlapping MCCAOPs as shown in FIG. 4.

In the example of FIG. 4, the timing parameters are as follows. A first MCCA reservation shown in the upper part of FIG. 4 is set to a DTIM interval of seven, an offset of one, a duration of one and a periodicity of two. A second MCCA reservation shown in the lower part of FIG. 4 is set to a DTIM interval of eleven, an offset of two, a duration of one and a periodicity of two. It can be easily seen in the example according to FIG. 4 that the reservations are shifting with respect to each other, so that it comes to disadvantageous overlapping of MCCAOPs in some DTIM intervals although the first DTIM interval was without overlap.

This recognized drawback led to an amendment in version D3.04 of the draft standard by imposing a requirement on all mesh stations of a wireless mesh network to deploy a DTIM interval of common length. However, version D3.04 of the draft standard did not define how to achieve this aim. Although this requirement may be suitable to achieve a synchronization within the mesh network, the problem of enforcing this requirement on the choice of the DTIM interval in a distributed wireless mesh network remains unsolved. As to the choice of an individual DTIM interval for each mesh station it is usually assumed that the requirement is fulfilled by some default value, by an external authority responsible for the configuration, or by a distributed configuration procedure which is still to be developed.

In order to implement a DTIM interval of common length, version D10.0 of the draft standard introduced a requirement on a mesh station to maintain a synchronization with its neighboring mesh stations using a DTIM interval with a duration of 2ⁿ multiplied by a constant of 100 TU or time units.

Although said requirement allows a configuration of nested DTIM intervals—larger DTIM intervals being multiples of the smallest one—the mandatory rule of this requirement removes most of the flexibility for setting the DTIM interval and restricts the possible DTIM interval values to a very limited number, which is not adequate for the possible usages of wireless mesh networks with MCCA.

These problems known in the art are herein addressed by an embodiment described below. According to this embodiment, a method in an IEEE 802.11s mesh network is described whereby the objective of this method is to obtain that the DTIM interval at mesh stations is set in a way that there is no relative shift of MCCAOPs between sequential DTIM intervals.

Hereinafter, a DTIM interval is understood as a time interval between consecutive beacons containing a delivery traffic indication message or DTIM. A DTIM is only present in beacons sent at the beginning of a new DTIM period. The value of the DTIM interval, expressed in time units, or TU, is equal to the product of a value in a Beacon Interval field and a value in a DTIM Period subfield. Said DTIM Period subfield is contained within an element captioned >>TIM<< or traffic indication map, the TIM being present in a beacon frame. One time unit corresponds to 1,024 μs.

Hereinafter, a mesh basic service set or MBSS is understood as a wireless mesh network according to IEEE 802.11s. A mesh station is understood as a mesh node in an MBSS.

Since mesh stations join a mesh network sequentially, there is a first mesh station in the mesh network. According to one embodiment, subsequent mesh stations will adopt the DTIM interval of the first mesh station, or in more general terms, of the mesh stations that are already a member of the MBSS, during mesh discovery following some restrictions in the choice of their DTIM interval.

After the determination of the active mesh profile, the mesh station may establish a new MBSS or become a new member to an existing MBSS. If the mesh station establishes a new MBSS, it uses the values for the DTIM interval, i.e. beacon interval and DTIM period, as configured. In other words, it can use any allowed value for the beacon interval and the DTIM period.

If the mesh station becomes a new member to an existing MBSS, hereinafter referred to as >>joining mesh station<<, and the joining mesh station has enabled MCCA (dot11MCCAActived is true), the joining mesh station learns its neighborhood DTIM intervals by receiving Beacon frames from neighboring mesh stations of the MBSS with >>dot11MCCAActivated<< equal to true.

According to one embodiment, the joining mesh station chooses its DTIM interval according to one of the following rules:

a) Same DTIM Interval

The DTIM interval of the joining mesh station is set to the same DTIM interval of one of the mesh stations of the MBSS from that the joining mesh station received Beacon frames or Probe Response frames with the MCCA Enabled subfield of the Mesh Capability field of the Mesh Configuration element equal to 1.

b) Multiple of DTIM Interval

The DTIM interval of the joining mesh station is set to a multiple of the DTIM interval of one of the mesh stations of the MBSS from that the joining mesh station received Beacon frames or Probe Response frames with the MCCA Enabled subfield of the Mesh Capability field of the Mesh Configuration element equal to 1. The factor is a power of 2 (e.g. 2, 4, 8, 16, 32, . . . )

c) Fraction of DTIM Interval

The DTIM interval of the joining mesh station is set to a fraction of the DTIM interval of one of the mesh stations of the MBSS from that the joining mesh station received Beacon frames or Probe Response frames with the MCCA Enabled subfield of the Mesh Capability field of the Mesh Configuration element equal to 1. The divisor is a power of 2, e.g. 2, 4, 8, 16, 32, etc.

In rules b) and c), the factor or divisor is advantageously a power of any number m being a positive integer, or, in other words, natural number.

Another requirement according to an alternative embodiment is that rules b) and c) always use the same number m in the same MBSS. This alternative embodiment ensures that DTIM intervals of different length fit into each other very nicely. That is, the end of the longest DTIM interval is also the end of any of the shorter DTIM intervals. This prevents the shifting of the relative position of MCCAOPs in subsequent DTIM intervals.

An advantageous choice of m=2 allows a rather natural and flexible way of finding multiples or fractions (double or half). It is also easy to compute by computers.

After the determination of the DTIM interval, the joining mesh station starts beaconing using the START primitive.

Of course, it would be beneficial if all mesh stations of a MBSS determine their DTIM interval according to the rules a), b), or c) independent of whether they use MCCA or not, that is, independent of the setting of the MCCA Enabled subfield.

The embodiments disclosed herein provide a simple mechanism that ensures that DTIM intervals of mesh stations in an MBSS fulfill certain conditions that ensure an advantageous repetition pattern of MCCAOPs. Especially, MCCAOPs of different neighboring mesh stations do not shift in their relative position in subsequent DTIM intervals.

In some embodiments, there is no need for any transmission of additional messages. All necessary information can be achieved with frames already provided by the draft standard transmitted, including beacons and probe response frames.

Embodiments of the invention may work in a distributed environment such as a wireless mesh network. Further, certain embodiments of the invention require only minimal external configuration efforts, only the configuration of the first mesh station of the mesh MBSS.

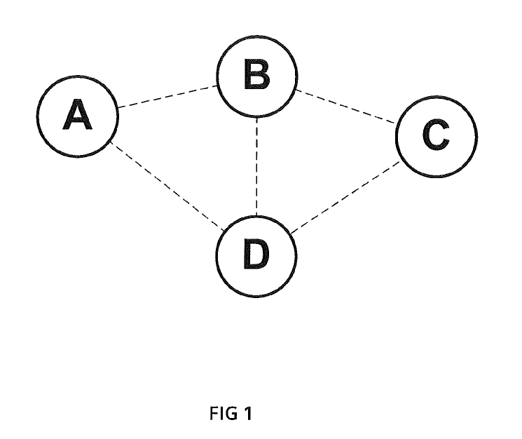

With reference to FIG. 1, an example embodiment is described. According to this embodiment, a wireless mesh network entitled >>Mesh_A<< is assumed, comprising mesh stations A, B, C and D as shown in FIG. 1.

The possible wireless connectivity is indicated by the dotted lines connecting the mesh stations. The mesh stations are being switched on and are joining the mesh >>Mesh_A<< in the following order: mesh station A first, than mesh station B followed by mesh station C and as the last one mesh station D. All mesh stations in >>Mesh_A<< have set a flag captioned >>dot11MCCAActivated<< to true, thereby expressing that a usage of MCCA is envisaged. A subfield captioned >>MCCA Enabled<< in the >>Mesh Capability<< field of the Mesh Configuration element in beacon frames and in probe response frames is set to true.

In a following phase, mesh station A is switched on. Mesh station A discovers that there is no MBSS available it can join. Therefore, mesh station A establishes the MBSS captioned >>Mesh_A<< with mesh station A as the only member. Since mesh station A establishes the MBSS >>Mesh_A<< as the initial mesh station, it chooses the configuration parameters for the DTIM interval according to some default or external configuration. Here the following values are assumed:
Beacon Interval: 1,000 TU
DTIM Period: 10
DTIM Interval=10,000 TU

In a following phase, mesh station B is switched on. Mesh station B discovers mesh station A announcing MBSS >>Mesh_A<< during the scanning process. Mesh station B sets its mesh profile in such a way that it can join >>Mesh_A<<. Since mesh station B has MCCA enabled, i.e. >>dot11MCCAActivated<< is set to true, and the MCCA Enabled subfield in the Mesh Capability field of the Mesh Configuration element in the beacon frames and probe response frames of mesh station A has been set to 1, mesh station B will follow the rules given in the particular embodiment in order to determine its DTIM interval. Mesh station B will follow rule b), multiple of DTIM interval, with a factor of two. Mesh station B will therefore use the following values:
Beacon Interval: 1,000 TU (is kept the same as beacon interval from mesh station A)
DTIM Period: 20 (is derived from DTIM interval and beacon interval)
DTIM Interval=20,000 TU (DTIM interval of mesh station A*2)

In order to achieve a DTIM interval of 20,000 TU, mesh station B could also use different values of beacon interval and DTIM period as long as their product is the required DTIM interval. An alternative configuration for the same DTIM interval is:
Beacon Interval: 2,000 TU
DTIM Period: 10
DTIM Interval=20,000 TU (DTIM interval of mesh station A*2)

In a following phase, mesh station C is switched on. Mesh station C discovers mesh station B announcing MBSS >>Mesh_A<< during the scanning process. Mesh station C cannot receive beacon frames or probe response frames from mesh station A. Mesh station C sets its mesh profile in such a way that it can join >>Mesh_A<<. Since mesh station C has MCCA enabled, i.e. >>dot11MCCAActivated<< is set to true, and the MCCA Enabled subfield in the Mesh Capability field of the Mesh Configuration element in the beacon frames and probe response frames of mesh station B has been equal to 1, mesh station C will follow the rules given in the particular embodiment in order to determine its DTIM interval. Mesh station C will follow rule c) (fraction of DTIM interval) with the divisor=2̂2=4. Mesh station C will therefore use the following values:
Beacon Interval: 1,000 TU (is kept the same as beacon interval from mesh station B)
DTIM Period: 5 (is derived from DTIM interval and beacon interval)
DTIM Interval=5,000 TU (DTIM interval of mesh station B/4)

In order to achieve a DTIM interval of 5,000 TU, mesh station C could also use different values of beacon interval and DTIM period as long as their product is the required DTIM interval. An alternative configuration for the same DTIM interval is:
Beacon Interval: 500 TU
DTIM Period: 10
DTIM Interval=5,000 TU (DTIM interval of mesh station B/4)

In a following phase, mesh station D is switched on. Mesh station D discovers mesh stations A, B, and C announcing MBSS >>Mesh_A<< during the scanning process. Mesh station D sets its mesh profile in such a way that it can join >>Mesh_A<<. Since mesh station D has MCCA enabled (>>dot11MCCAActivated<< is true) and the MCCA Enabled subfield in the Mesh Capability field of the Mesh Configuration element in the beacon frames and probe response frames of mesh stations A, B, and C has been equal to 1, mesh station D will follow the rules given in the particular embodiment in order to determine its DTIM interval. Mesh station D will follow rule a) (same DTIM interval) with respect to mesh station A. Mesh station D will therefore use the following values:
Beacon Interval: 1,000 TU (same as beacon interval from mesh station A)
DTIM Period: 10 (same as DTIM period from mesh station A)
DTIM Interval=10,000 TU (same as DTIM interval of mesh station A)

In order to achieve a DTIM interval of 10,000 TU, mesh station D could also use different values of beacon interval and DTIM period as long as their product is the required DTIM interval. An alternative configuration for the same DTIM interval is:
Beacon Interval: 2,000 TU
DTIM Period: 5
DTIM Interval=10,000 TU (same as DTIM interval of mesh station A)

The mesh stations of MBSS >>Mesh_A<< have now the following values for their DTIM interval:
mesh station A: 10,000 TU
mesh station B: 20,000 TU
mesh station C: 5,000 TU
mesh station D: 10,000 TU.

Applying these settings, there is no shifting of MCCAOP between subsequent DTIM intervals as can be seen in FIG. 4.

Embodiments of the invention can be implemented in computing hardware (computing apparatus) and/or software, including but not limited to any computer or microcomputer that can store, retrieve, process and/or output data and/or communicate with other computers.

The processes can also be distributed via, for example, downloading over a network such as the Internet. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW.

The invention has been described in detail with particular reference to preferred embodiments thereof and examples, but it will be understood that variations and modifications can be effected within the spirit and scope of the invention covered by the claims.

What is claimed is:

1. A method for setting a DTIM interval of a mesh station joining a wireless mesh network based on the specifications of IEEE 802.11s, the method comprising:
determining, by the joining mesh station, a DTIM interval of at least one mesh station being a member of the wireless mesh network, and
setting, by the joining mesh station, a DTIM interval of the joining mesh station, the DTIM interval being one of:
the same DTIM interval of at least one mesh station being a member of the wireless mesh network;
a multiple of the DTIM interval of at least one mesh station being a member of the wireless mesh network wherein the factor is a positive integer; and
a fraction of the DTIM interval of at least one mesh station being a member of the wireless mesh network wherein the divisor is a positive integer.

2. A method according to claim 1, wherein said factor or said divisor is a power of a positive integer with a coefficient being a non-negative integer.

3. A method according to claim 2, wherein said positive integer is a value of two.

4. A method according to claim 2, wherein said positive integer is identical for all mesh stations of said wireless mesh network including said joining mesh station.

5. A node of a mesh network, the node comprising a processor programmed to:
determine a DTIM interval of at least one mesh station being a member of the wireless mesh network, and
set a DTIM interval of the joining mesh station, the DTIM interval being one of:
the same DTIM interval of at least one mesh station being a member of the wireless mesh network;
a multiple of the DTIM interval of at least one mesh station being a member of the wireless mesh network wherein the factor is a positive integer; and
a fraction of the DTIM interval of at least one mesh station being a member of the wireless mesh network wherein the divisor is a positive integer.

6. A node according to claim 5, wherein said factor or said divisor is a power of a positive integer with a coefficient being a non-negative integer.

7. A node according to claim 6, wherein said positive integer is a value of two.

8. A node according to claim 6, wherein said positive integer is identical for all mesh stations of said wireless mesh network including said joining mesh station.

9. A computer program product comprising a program code stored in non-transitory computer-readable media and executable by a processor of a node in a mesh network to:
determine a DTIM interval of at least one mesh station being a member of the wireless mesh network, and
set a DTIM interval of the joining mesh station, the DTIM interval being one of:
the same DTIM interval of at least one mesh station being a member of the wireless mesh network;
a multiple of the DTIM interval of at least one mesh station being a member of the wireless mesh network wherein the factor is a positive integer; and
a fraction of the DTIM interval of at least one mesh station being a member of the wireless mesh network wherein the divisor is a positive integer.

10. A computer program product according to claim 9, wherein said factor or said divisor is a power of a positive integer with a coefficient being a non-negative integer.

11. A computer program product according to claim 10, wherein said positive integer is a value of two.

12. A computer program product according to claim 10, wherein said positive integer is identical for all mesh stations of said wireless mesh network including said joining mesh station.
